(19) United States
(12) Patent Application Publication
(10) Pub. No.: US 2014/0312204 A1
(43) Pub. Date: Oct. 23, 2014

(54) FROZEN SNACK PREPARATION SYSTEM

(71) Applicant: Michael A. Bondi, Minneapolis, MN (US)

(72) Inventor: Michael A. Bondi, Minneapolis, MN (US)

(21) Appl. No.: 14/179,498

(22) Filed: Feb. 12, 2014

Related U.S. Application Data
(60) Provisional application No. 61/763,754, filed on Feb. 12, 2013.

(51) Int. Cl. A23G 9/08

(52) U.S. Cl. CPC A23G 9/083
USPC 249/176

(57) ABSTRACT

A frozen snack preparation system including a plurality of product containers, a stand and an insertion device. Each of the product containers has an opening. The stand has a plurality of receptacles formed therein. Each of the receptacles is adapted to receive one of the product containers. The insertion device has a plurality of openings formed therein. The plurality of openings are aligned with the plurality of receptacles when the insertion device is in engagement with the stand.

### REFERENCE TO RELATED APPLICATION

This application claims priority to U.S. Applic. No. 61/763,754, which was filed on Feb. 12, 2013. The contents of which are incorporated herein by reference.

### FIELD OF THE INVENTION

The invention relates generally to a system for preparing food products. More particularly, the invention relates to a system for preparing frozen snacks.

### BACKGROUND OF THE INVENTION

Frozen desserts have been a part of civilization for a very long time. The ancient Romans had blocks of ice carried down from the mountains in the summer. The blocks were ground into crushed ice that was flavored with fruit and syrup. The Chinese are credited with the same practice, and these sherbets, sorbets, and frozen ices were served in the thirteenth century court of Kublai Khan (1215-1294) when the Italian adventurer Marco Polo (1254-1324) visited.

Other ancient cultures including those of Turkey, Persia (now Iran), the Arabian Peninsula, and India also knew of frozen, flavored ices. They were usually a privilege of the wealthy and were made of ice, fruit pulp, fruit syrup, and flowers for flavor, fragrance, and color. Frozen treats were served to honor guests at banquets or to cleanse the palate between courses, as sorbets are still used today.

The invention of the frozen pop is attributed to Frank Epperson, who in 1905, as an 11-year-old, mixed powdered soda pop and water to create a drink, as was popular at the time. Epperson forgot about his preparation and left it outside on the porch of his home in Oakland, Calif. Due to an unexpected cold spell, the concoction froze overnight, and the stick he had used to stir the powder in the water stuck in the frozen liquid.

Epperson pulled out the whole frozen mass and found that he had invented a new treat. He named it the “Epperson icicle.” The following summer, he made his frozen treats in his family's icebox and sold them around his neighborhood under the shortened name of “Epsicle.” Frank again rechristened his discovery the “popsicle” to show that they were made from soda pop.

Another popular frozen confection is sold in the form of a cylindrical paper tube filled with frozen sherbet or similar substance. One of the more widely available brands of such confections is the nearly ubiquitous the “push-up”®. A cylindrical plug in the bottom of the tube is attached to a stick, which is used both as a handle and to push the sherbet above the tube for consumption.

Although both popsicles® and push-ups® are provided with integral handles, the art has developed several forms of auxiliary grips for such confections. For example, Hoeting, U.S. Pat. No. 5,993,870, discusses a holder and coating device for use with handle-mounted confectionery products such as lollipops, or ice cream treats or the like.

The confectionery holder holds and stores both a handle-mounted confectionery product and an edible topping of a particulate material, and facilitates coating the confectionery product with the topping. The holder has a base and a removable cover for gaining access to the confectionery product. The base holds a supply of the edible coating. When the device is manipulated, the edible coating is applied to the confectionery product.

Berg, U.S. Pat. No. 3,459,296, is directed to a container for a portion of an iced confection that can be exposed for eating. The container comprises an open-ended body portion conforming to the shape of the confection and a bottom having a hollow tubular handle extended through the opening in the bottom of the body portion.

Another form frozen snacks may be provided is in an elongated tube. The tube contains a liquid that may be colored or flavored. The liquid in the tube may have sufficient stability so that it does not need to be maintained at a low temperature during distribution. After purchase the tube is placed in a freezer until the liquid at least partially solidifies.

When it is desired to consume the now frozen liquid, one end of the tube is cut off to provide access to the frozen liquid. The frozen liquid may be dispensed from the tube by pushing the frozen liquid towards the open end of the tube. This product is typically referred to as a freezie. The tubes are typically distributed in packages that may include a variety of flavors and colors so that persons desiring to consume the freezies can select a preferred flavor or color.

### SUMMARY OF THE INVENTION

An embodiment of the invention is directed to a frozen snack preparation system that includes a stand, an insertion device and a plurality of receptacles. The frozen snack preparation system enables products to be prepared in the receptacles so that the snack products may be readily consumed.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a front view of a frozen snack preparation system according to an embodiment of the invention.

FIG. 2 is a side view of the frozen snack preparation system of FIG. 1.

FIG. 3 is a top view of the frozen snack preparation system of FIG. 1.

FIG. 4 is a front view of an alternative embodiment of the frozen snack preparation system.

FIG. 5 is a side view of the frozen snack preparation system of FIG. 4.

FIG. 6 is a top view of the frozen snack preparation system of FIG. 4.

FIG. 7 is a front view of an alternative embodiment of the frozen snack preparation system.

FIG. 8 is a side view of the frozen snack preparation system of FIG. 7.

FIG. 9 is a top view of the frozen snack preparation system of FIG. 7.

### DETAILED DESCRIPTION OF THE PREFERRED EMBODIMENTS

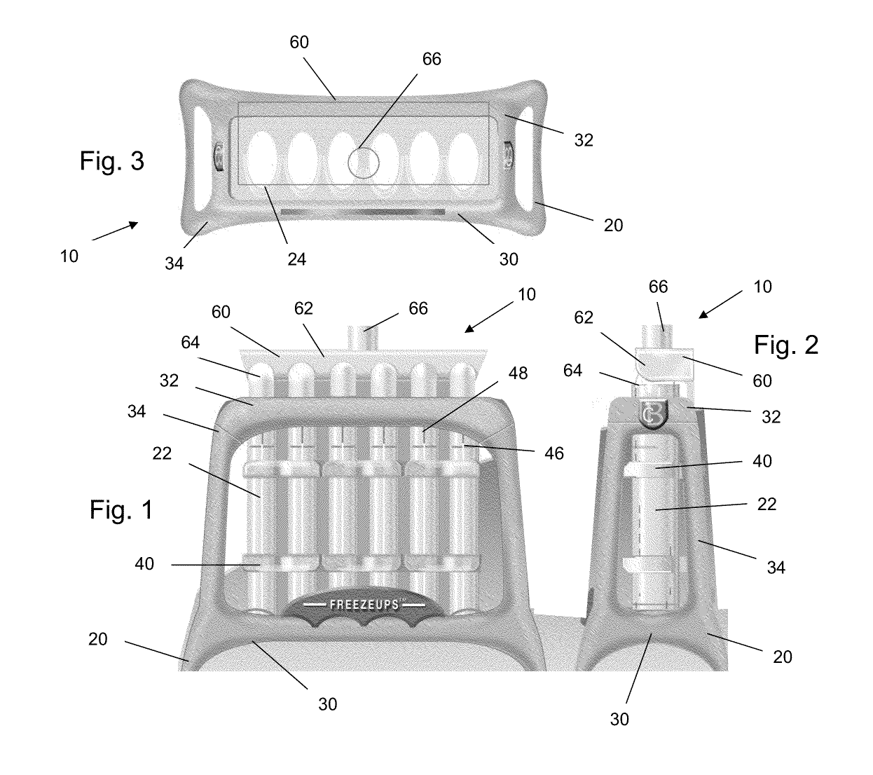

An embodiment of the invention is directed to a frozen snack preparation system, as illustrated at 10 in FIGS. 1-3. The frozen snack preparation system 10 may include a stand 20 to hold at least one tube 22 during a filling process in which a liquid is placed in the at least one tube 22.

The stand 20 may have a generally upright configuration as illustrated in the figures. Providing the stand 20 with an upright configuration enables the at least one tube 22 to be held in an upright configuration to facilitate placing a liquid into the at least one tube 22.

The stand 20 includes at least one receptacle 24 in which the at least one tube 22 may be positioned prior to the filling process. In certain embodiments, the stand 20 may include between two and ten receptacles. In other embodiments, the stand 20 may include six receptacles as illustrated in FIGS. 1-3.

The number of receptacles 24 and the associated arrangement of the receptacles 24 may be selected based upon factors such as the number of tubes it is desired to simultaneously prepare. The receptacles 24 may be oriented in a variety of configurations using the concepts of the invention. One such orientation of the receptacles 24 is generally aligned to form a line. Other possible configurations for the receptacles 24 include an array having more than one line of receptacles 24 such as two lines that each include four receptacles 24.

In certain embodiments, the receptacle 24 may have a generally cylindrical or elliptical shape that corresponds to the filled shape of the tube 22. The receptacle 24 may extend substantially along a length of the tube 22. While such a configuration would enhance the support provided to the tube 22, it may increase the cost to manufacture the stand 20. In configurations where the tube 22 extends substantially along a length of the tube 22, a portion of the receptacle 24 may be transparent to view the level of liquid in the tube 22 during the filling process.

The stand 20 may include a lower tube support 30 and an upper tube support 32 that are interconnected with at least one side support 34. A distance between the lower tube support 30 and the upper tube support 32 may be selected based upon a length of the tube 22 that is being used in conjunction with the stand 20 so that when a lower end of the tube 22 is placed proximate the lower tube support 30, an upper end of the tube 22 extends to proximate the upper tube support 32.

In certain embodiments, the upper end of the tube 22 extends above the upper tube support 32. Using such a configuration enables a person using the invention to view the level of the liquid in the tube 22 to prevent the tube 22 from being overfilled. As is discussed in more detail below, the placement of the upper tube support 32 may enable a fill line on the tube 22 to be viewed during the filling process. This configuration also enables a person using the invention to grasp the upper end of the tube 22 and then close the open end of the tube 22.

While the figures illustrate that the lower tube support 30 and the upper tube support 32 are mounted in a stationary position with respect to each other, it is possible to mount at least one of the lower tube support 30 and the upper tube support 32 in a movable configuration to adjust a distance between the lower tube support 30 and the upper tube support 32. Such a configuration would enable the invention to be used with tubes 22 having different lengths.

The lower tube support 30 may be substantially flat or may include at least one recess formed therein that is indicative of the location at which the bottoms of the tubes 22 should be placed during the filling process. The lower tube support 30 thereby supports the tubes 22 during the filling process so that the tubes 22 can all be filled at the same time.

The lower tube support 30 may define a trough having raised edges. The trough would thereby collect any liquid that is potentially spilled during the process of filling the tubes. Increasing a height of the edges would increase the volume of liquid that could be retained on the lower tube support 30.

The upper tube support 32 may have the receptacles 24 formed therein. Such a configuration provides support to the upper end of the tubes 22 while the tubes 22 are being filled with liquid. In certain embodiments, the receptacle 24 is an aperture formed in the upper tube support 32.

The stand 20 may be fabricated so that a length and/or depth of the stand 20 is greater proximate a lower end thereof as illustrated in the figures. Forming the stand 20 with this configuration enhances the stability of the stand and thereby reduces the potential of the stand being tipped over during the filling process because if the stand 20 is tipped over during the filling process, the liquid being placed in the tubes 22 could spill.

The stand 20 may be fabricated so that it is substantially symmetrical. For example, the stand 20 may have front and back sides that are shaped substantially similar to each other. Forming the stand 20 with this configuration enables the front and back sides to be molded in a single mold cavity and then attached to each other after the molding process is completed.

The stand 20 may be fabricated from a variety of materials using the concepts of the invention. The materials used to fabricate the stand 20 should resist degradation during use as well have sufficient strength so that the stand is not likely to break during use.

Depending on a variety of factors such as the length of the tubes 22 and the material from which the tubes 22 are fabricated, at least one intermediate support 40 may be provided. The at least one intermediate support 40 may be positioned along at least one of the front side and the back side of the tube 22. The intermediate support 40 may also partially extend around a surface of the tubes 22. In certain embodiments, the at least one intermediate support 40 includes at least one recess formed therein that substantially conform to a shape of the tubes 22 when filled with liquid.

The at least one intermediate support 40 may be integrally formed with the other portions of the stand 20. Alternatively, the at least one intermediate support 40 may be formed separately from the other portions of the stand 20 and then attached to the stand 20 in the manufacturing process.

Alternatively or additionally to providing a fill line on the tube 22, a fill line may be provided on one of the components of the stand. The fill line thereby enables a person using the invention to see the level of liquid being placed into the tube 22 to thereby avoid overfilling the tube 22.

The tube 22 may have a generally elongated configuration having an opening proximate an end thereof. Forming the tube 22 with this configuration enables the tube 22 to be held in a person's hand when the product placed in the tube 22 is being consumed. It is possible for the tube 22 to have other configurations. Examples of such alternative configurations include square, triangular and circular.

In certain embodiments, the tube 22 may be formed with a generally cylindrical configuration. In other embodiments, the tube 22 may be formed with a rectangular configuration.

The tube 22 may be formed with a variety of capacities depending on the type of product that is desired to be placed into the tube 22 as well as the intended consumer. In certain embodiments, the tube 22 may have a capacity of up to about 200 milliliters. In other embodiments, the tube 22 may have a capacity of between about 20 milliliters and about 150 milliliters.

The tube 22 may be fabricated from a variety of materials using the concepts of the invention. In certain embodiments, at least a portion of the tube 22 may be formed from a transparent material so that a person using the invention could view the level of liquid in the tube 22.

While it is possible to form the tube 22 from a generally rigid material that retains a cylindrical or elliptical profile when not filed with liquid, the tube 22 may be fabricated from a flexible material that collapses when the tube 22 is not filled with liquid. Providing the tube 22 with a flexible configuration enables the tube 22 to be collapsed during the distribution process prior to use.

In certain embodiments, the tube 22 is fabricated from a plastic material. The material from which the tube 22 should exhibit sufficient structural rigidity so that the at least one tube does not weaken to an extent such that the liquid could leak from the tube 22 at ambient temperatures as well as the reduced temperatures in a conventional residential freezer.

A fill line 46 may be provided on the tube 22 to indicate to persons using the invention how much liquid should be placed in the tube 22. The fill line 46 may be placed in a spaced-apart configuration from the closure mechanism 48 to account for expansion of the liquid placed in the tube 22 when frozen. This configuration thereby minimizes the potential of the closure mechanism failing, which could permit the liquid to leak from the tube 22.

The tube 22 may be provided with a closure mechanism 48 to maintain the tube 22 in a closed configuration after a liquid is placed therein. In certain embodiments, a zipper-type plastic closure system may be provided on the tube 22 proximate an open end thereof. The zipper-type closure mechanism may be similar to aspects of a closure provided on a ZIPLOC bag.

Alternatively or additionally, a closure mechanism (not shown) may be placed over the open end of the at least one tube. In certain embodiments, the closure mechanism may include two sections that are pivotally mounted to each other. A fastener may be provided opposite the pivotal attachment end to maintain the sections in a closed configuration.

The frozen snack preparation system may also include an insertion device 60, as illustrated in FIGS. 1-3. The insertion device 60 may facilitate placing the tubes 22 into the stand 20. The insertion device 60 may also facilitate placing the liquid into the tubes 22.

The insertion device may include a cross member 62 from which a plurality of fingers 64 extend. The number of fingers 64 may correspond to the number of receptacles 24 on the stand 20.

The fingers 64 may have a length that is less than a length of the tubes 22. The fingers 64 may have an at least partially cylindrical shape. Forming the fingers 64 with the at least partially cylindrical shape enables the fingers 64 to move the tubes 22 from a collapsed configuration to a partially expanded configuration. Moving the tubes 22 to the partially expanded configuration facilitates positioning the tubes 22 in the stand 20 as well as facilitates placing liquid in the tubes 22.

A distal end of the fingers 64 may be curved to minimize the potential of the fingers 64 damaging the tubes 22 as the fingers 64 are inserted into the tubes 22. Alternatively or additionally, the fingers 64 may have a tapered profile so that the fingers 64 are smaller proximate a distal end thereof. This configuration may enhance the ability to insert the fingers 64 into the tubes 22.

The fingers 64 may be in fluid communication with the cross member 62 so that a liquid placed in the cross member 62 flows into the fingers 64 and then into the tubes 22. In certain embodiments, the cross member 62 includes an upper side that is at least partially open. Forming the cross member 62 with this configuration allows liquid to be poured into the cross member 62 and then directed into the tubes 22 through the fingers 64.

The cross member 62 may have a U-shaped profile where an open end is oriented upwardly. The fingers 64 may intersect the cross member 62 proximate a lower portion of the U-shape.

Alternatively, it is possible to substantially close the cross member 62 except for an aperture 66 extending from an upper surface thereof as illustrated in the figures. The liquid may be poured into the cross member 62 through the aperture 66. Depending on factors such as the size of the aperture 66 and the rate at which it is desired to fill the tubes 22, a funnel (not shown) may be placed in the aperture 66 to reduce the potential of liquid being spilled during the filling process.

An interior region of the cross member 62 may include at least one divider that extends from proximate the aperture 66 to proximate one of the fingers 64. Since the insertion device 60 is generally symmetrical, each side of the cross member 62 may include two dividers to separate liquid flowing along each side into three liquid flow paths that are each associated with one of the fingers 64.

A support 68 may extend from the cross member 62 to the stand 20 to maintain the cross member 62 in a spaced-apart configuration from the top of the stand 20 so that the tops of the tubes 22 are not crushed when the insertion device 60 is placed on the stand 20.

The insertion device 60 may be fabricated so that it is substantially symmetrical. For example, the insertion device 60 may have front and back sides that are shaped substantially similar to each other. Forming the insertion device 60 with this configuration enables the front and back sides to be molded in a single mold cavity and then attached to each other after the molding process is completed.

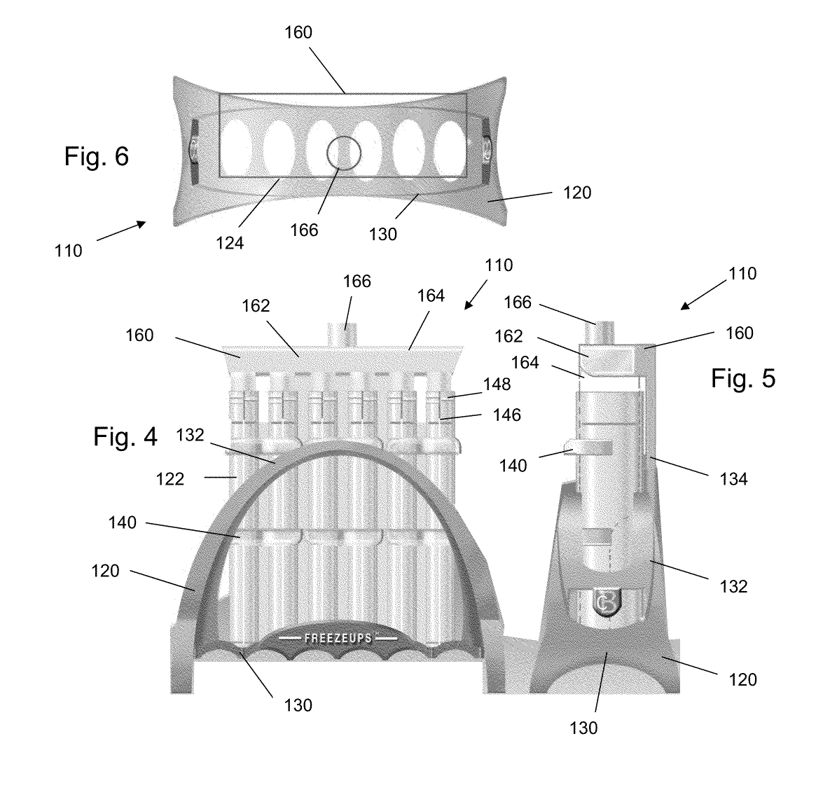

An alternative embodiment of the frozen snack preparation system, as illustrated at 110 in FIGS. 4-6. Similar to the embodiment illustrated in FIGS. 1-3, the frozen snack preparation system 110 may include a stand 120 to hold at least one tube 122 during a filling process in which a liquid is placed in the at least one tube 122.

The stand 120 may have a generally upright configuration as illustrated in the figures. Providing the stand 120 with an upright configuration enables the at least one tube 122 to be held in an upright configuration to facilitate placing a liquid into the at least one tube 122.

The stand 120 includes at least one receptacle 124 in which the at least one tube 122 may be positioned prior to the filling process. In certain embodiments, the stand 120 may include between two and ten receptacles. In other embodiments, the stand 120 may include six receptacles as illustrated in FIGS. 4-6.

The number of receptacles 124 and the associated arrangement of the receptacles 124 may be selected based upon factors such as the number of tubes it is desired to simultaneously prepare. The receptacles 124 may be oriented in a variety of configurations using the concepts of the invention. One such orientation of the receptacles 124 is generally aligned to form a line. Other possible configurations for the receptacles 124 include an array having more than one line of receptacles 124 such as two lines that each include four receptacles 124.

In certain embodiments, the receptacle 124 may have a generally cylindrical or elliptical shape that corresponds to the filled shape of the tube 122. The receptacle 124 may extend substantially along a length of the tube 122. While such a configuration would enhance the support provided to the tube 122, it may increase the cost to manufacture the stand 120. In configurations where the tube 122 extends substantially along a length of the tube 122, a portion of the receptacle 124 may be transparent to view the level of liquid in the tube 122 during the filling process.

The stand 120 may include a lower tube support 130 and an upper tube support 132 that has a generally arch shaped-configuration. A distance between the lower tube support 130 and the upper tube support 132 may be selected based upon a length of the tube 122 that is being used in conjunction with the stand 120 so that when a lower end of the tube 122 is placed proximate the lower tube support 130, an upper end of the tube 122 extends to proximate the upper tube support 132.

In certain embodiments, the upper end of the tube 122 extends above the upper tube support 132. Using such a configuration enables a person using the invention to view the level of the liquid in the tube 122 to prevent the tube 122 from being overfilled. As is discussed in more detail below, the placement of the upper tube support 132 may enable a fill line on the tube 122 to be viewed during the filling process. This configuration also enables a person using the invention to grasp the upper end of the tube 122 and then close the open end of the tube 122.

In addition to the upper tube support 132, the invention may include a back support 134 that is attached to at least one of the lower tube support 130 and the upper tube support 132. Especially proximate opposite ends of the arched upper tube support 132, the back support 134 may extend above the upper tube support 132. The receptacle 124 may be mounted with respect to the back support 134

While the figures illustrate that the lower tube support 130 and the upper tube support 132 are mounted in a stationary position with respect to each other, it is possible to mount at least one of the lower tube support 130 and the upper tube support 132 in a movable configuration to adjust a distance between the lower tube support 130 and the upper tube support 132. Such a configuration would enable the invention to be used with tubes 122 having different lengths.

The lower tube support 130 may be substantially flat or may include at least one recess formed therein that is indicative of the location at which the bottoms of the tubes 122 should be placed during the filling process. The lower tube support 130 thereby supports the tubes 122 during the filling process so that the tubes 122 can all be filled at the same time.

The lower tube support 130 may define a trough having raised edges. The trough would thereby collect any liquid that is potentially spilled during the process of filling the tubes 122. Increasing a height of the edges would increase the volume of liquid that could be retained on the lower tube support 30.

The upper tube support 132 may have the receptacles 124 formed therein. Such a configuration provides support to the upper end of the tubes 122 while the tubes 122 are being filled with liquid. In certain embodiments, the receptacle 124 is an aperture formed in the upper tube support 132.

The stand 120 may be fabricated so that a length and/or depth of the stand 120 is greater proximate a lower end thereof as illustrated in the figures. Forming the stand 120 with this configuration enhances the stability of the stand and thereby reduces the potential of the stand being tipped over during the filling process because if the stand 120 is tipped over during the filling process, the liquid being placed in the tubes 122 could spill.

The stand 120 may be fabricated so that it is substantially symmetrical. For example, the stand 120 may have front and back sides that are shaped substantially similar to each other. Forming the stand 120 with this configuration enables the front and back sides to be molded in a single mold cavity and then attached to each other after the molding process is completed.

The stand 120 may be fabricated from a variety of materials using the concepts of the invention. The materials used to fabricate the stand 120 should resist degradation during use as well have sufficient strength so that the stand is not likely to break during use.

Depending on a variety of factors such as the length of the tubes 122 and the material from which the tubes 122 are fabricated, at least one intermediate support 140 may be provided. The at least one intermediate support 40 may be positioned along at least one of the front side and the back side of the tube 122. The intermediate support 140 may also partially extend around a surface of the tubes 122. In certain embodiments, the at least one intermediate support 140 includes at least one recess formed therein that substantially conform to a shape of the tubes 122 when filled with liquid.

The at least one intermediate support 140 may be integrally formed with the other portions of the stand 120. Alternatively, the at least one intermediate support 140 may be formed separately from the other portions of the stand 120 and then attached to the stand 120 in the manufacturing process.

Alternatively or additionally to providing a fill line on the tube 122, a fill line may be provided on one of the components of the stand. The fill line thereby enables a person using the invention to see the level of liquid being placed into the tube 122 to thereby avoid overfilling the tube 22.

The tube 122 may have a generally elongated configuration having an opening proximate an end thereof. Forming the tube 122 with this configuration enables the tube 122 to be held in a person's hand when the product placed in the tube 122 is being consumed. It is possible for the tube 122 to have other configurations. Examples of such alternative configurations include square, triangular and circular.

In certain embodiments, the tube 122 may be formed with a generally cylindrical configuration. In other embodiments, the tube 122 may be formed with a rectangular configuration.

The tube 122 may be formed with a variety of capacities depending on the type of product that is desired to be placed into the tube 122 as well as the intended consumer. In certain embodiments, the tube 122 may have a capacity of up to about 200 milliliters. In other embodiments, the tube 122 may have a capacity of between about 20 milliliters and about 150 milliliters.

The tube 122 may be fabricated from a variety of materials using the concepts of the invention. In certain embodiments, at least a portion of the tube 122 may be formed from a transparent material so that a person using the invention could view the level of liquid in the tube 122.

While it is possible to form the tube 122 from a generally rigid material that retains a cylindrical or elliptical profile when not filed with liquid, the tube 122 may be fabricated from a flexible material that collapses when the tube 122 is not filled with liquid. Providing the tube 122 with a flexible configuration enables the tube 122 to be collapsed during the distribution process prior to use.

In certain embodiments, the tube 122 is fabricated from a plastic material. The material from which the tube 122 should exhibit sufficient structural rigidity so that the at least one tube does not weaken to an extent such that the liquid could leak from the tube 122 at ambient temperatures as well as the reduced temperatures in a conventional residential freezer.

A fill line 146 may be provided on the tube 122 to indicate to persons using the invention how much liquid should be placed in the tube 122. The fill line 146 may be placed in a spaced-apart configuration from the closure mechanism 148 to account for expansion of the liquid placed in the tube 122 when frozen. This configuration thereby minimizes the potential of the closure mechanism failing, which could permit the liquid to leak from the tube 122.

The tube 122 may be provided with a closure mechanism 148 to maintain the tube 122 in a closed configuration after a liquid is placed therein. In certain embodiments, a zipper-type plastic closure system may be provided on the tube 122 proximate an open end thereof. The zipper-type closure mechanism may be similar to aspects of a closure provided on a ZIPLOC bag.

Alternatively or additionally, a closure mechanism (not shown) may be placed over the open end of the at least one tube. In certain embodiments, the closure mechanism may include two sections that are pivotally mounted to each other. A fastener may be provided opposite the pivotal attachment end to maintain the sections in a closed configuration.

The frozen snack preparation system may also include an insertion device 160, as illustrated in FIGS. 4-6. The insertion device 160 may facilitate placing the tubes 122 into the stand 120. The insertion device 160 may also facilitate placing the liquid into the tubes 122.

The insertion device may include a cross member 162 from which a plurality of fingers 164 extend. The number of fingers 164 may correspond to the number of receptacles 124 on the stand 120.

The fingers 164 may have a length that is less than a length of the tubes 122. The fingers 164 may have an at least partially cylindrical shape. Forming the fingers 164 with the at least partially cylindrical shape enables the fingers 164 to move the tubes 122 from a collapsed configuration to a partially expanded configuration. Moving the tubes 122 to the partially expanded configuration facilitates positioning the tubes 122 in the stand 120 as well as facilitates placing liquid in the tubes 122.

A distal end of the fingers 164 may be curved to minimize the potential of the fingers 164 damaging the tubes 122 as the fingers 164 are inserted into the tubes 122. Alternatively or additionally, the fingers 164 may have a tapered profile so that the fingers 164 are smaller proximate a distal end thereof. This configuration may enhance the ability to insert the fingers 164 into the tubes 122.

The fingers 164 may be in fluid communication with the cross member 162 so that a liquid placed in the cross member 162 flows into the fingers 164 and then into the tubes 122. In certain embodiments, the cross member 162 includes an upper side that is at least partially open. Forming the cross member 162 with this configuration allows liquid to be poured into the cross member 162 and then directed into the tubes 122 through the fingers 164.

The cross member 162 may have a U-shaped profile where an open end is oriented upwardly. The fingers 164 may intersect the cross member 162 proximate a lower portion of the U-shape.

Alternatively, it is possible to substantially close the cross member 162 except for an aperture 166 extending from an upper surface thereof as illustrated in the figures. The liquid may be poured into the cross member 162 through the aperture 166. Depending on factors such as the size of the aperture 166 and the rate at which it is desired to fill the tubes 122, a funnel (not shown) may be placed in the aperture 166 to reduce the potential of liquid being spilled during the filling process.

An interior region of the cross member 162 may include at least one divider that extends from proximate the aperture 166 to proximate one of the fingers 164. Since the insertion device 160 is generally symmetrical, each side of the cross member 162 may include two dividers to separate liquid flowing along each side into three liquid flow paths that are each associated with one of the fingers 164.

A support 168 may extend from the cross member 162 to the stand 120 to maintain the cross member 162 in a spaced-apart configuration from the top of the stand 120 so that the tops of the tubes 122 are not crushed when the insertion device 160 is placed on the stand 120.

The insertion device 160 may be fabricated so that it is substantially symmetrical. For example, the insertion device 160 may have front and back sides that are shaped substantially similar to each other. Forming the insertion device 160 with this configuration enables the front and back sides to be molded in a single mold cavity and then attached to each other after the molding process is completed.

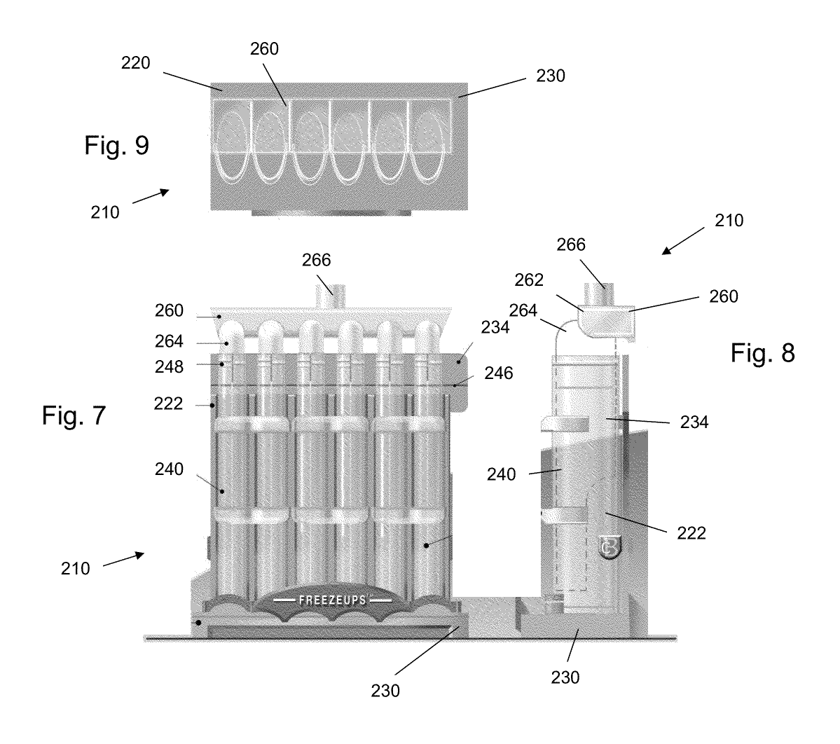

An alternative embodiment of the frozen snack preparation system, as illustrated at 210 in FIGS. 7-9. Similar to the embodiment illustrated in FIGS. 1-3, the frozen snack preparation system 210 may include a stand 220 to hold at least one tube 222 during a filling process in which a liquid is placed in the at least one tube 222.

The stand 220 may have a generally upright configuration as illustrated in the figures. Providing the stand 220 with an upright configuration enables the at least one tube 222 to be held in an upright configuration to facilitate placing a liquid into the at least one tube 222.

The stand 220 includes at least one receptacle 224 in which the at least one tube 222 may be positioned prior to the filling process. In certain embodiments, the stand 220 may include between two and ten receptacles. In other embodiments, the stand 220 may include six receptacles as illustrated in FIGS. 4-6.

The number of receptacles 224 and the associated arrangement of the receptacles 224 may be selected based upon factors such as the number of tubes it is desired to simultaneously prepare. The receptacles 224 may be oriented in a variety of configurations using the concepts of the invention. One such orientation of the receptacles 224 is generally aligned to form a line. Other possible configurations for the receptacles 224 include an array having more than one line of receptacles 224 such as two lines that each include four receptacles 224.

In certain embodiments, the receptacle 224 may have a generally cylindrical or elliptical shape that corresponds to the filled shape of the tube 222. The receptacle 224 may extend substantially along a length of the tube 222. While such a configuration would enhance the support provided to the tube 222, it may increase the cost to manufacture the stand 220. In configurations where the tube 222 extends substantially along a length of the tube 222, a portion of the receptacle 224 may be transparent to view the level of liquid in the tube 222 during the filling process.

The stand 220 may include a lower tube support 230 and a back tube support 234. A height of the back tube support 234 may be selected based upon a length of the tube 222 that is being used in conjunction with the stand 220 so that when a lower end of the tube 222 is placed proximate the lower tube support 230, an upper end of the tube 222 extends to proximate the upper end of the back tube support 234.

In certain embodiments, the upper end of the tube 222 extends above the upper end of the back tube support 234. Using such a configuration enables a person using the invention to view the level of the liquid in the tube 222 to prevent the tube 222 from being overfilled. As is discussed in more detail below, the placement of the back tube support 234 may enable a fill line on the tube 222 to be viewed during the filling process. This configuration also enables a person using the invention to grasp the upper end of the tube 222 and then close the open end of the tube 222.

The lower tube support 130 may be substantially flat or may include at least one recess formed therein that is indicative of the location at which the bottoms of the tubes 222 should be placed during the filling process. The lower tube support 230 thereby supports the tubes 222 during the filling process so that the tubes 222 can all be filled at the same time.

The stand 220 may be fabricated so that a length and/or depth of the stand 220 is greater proximate a lower end thereof as illustrated in the figures. Forming the stand 220 with this configuration enhances the stability of the stand and thereby reduces the potential of the stand being tipped over during the filling process because if the stand 220 is tipped over during the filling process, the liquid being placed in the tubes 222 could spill.

The stand 220 may be fabricated from a variety of materials using the concepts of the invention. The materials used to fabricate the stand 220 should resist degradation during use as well have sufficient strength so that the stand is not likely to break during use.

Depending on a variety of factors such as the length of the tubes 222 and the material from which the tubes 222 are fabricated, at least one intermediate support 240 may be provided.

The intermediate support 240 may have the receptacles 224 formed therein. Such a configuration provides support to the upper end of the tubes 222 while the tubes 222 are being filled with liquid. In certain embodiments, the receptacle 224 is an aperture formed in the upper tube support 32.

The at least one intermediate support 240 may be positioned along at least one of the front side and the back side of the tube 222. The intermediate support 240 may also partially extend around a surface of the tubes 122. In certain embodiments, the at least one intermediate support 240 includes at least one recess formed therein that substantially conform to a shape of the tubes 222 when filled with liquid.

The at least one intermediate support 240 may be integrally formed with the other portions of the stand 220. Alternatively, the at least one intermediate support 240 may be formed separately from the other portions of the stand 220 and then attached to the stand 220 in the manufacturing process.

It is possible to mount the at least one intermediate support 240 in a movable configuration with respect to the back tube support 234 to adjust a distance between the lower tube support 230 and the at least one intermediate support 240. Such a configuration would enable the invention to be used with tubes 22 having different lengths.

Alternatively or additionally to providing a fill line on the tube 222, a fill line may be provided on one of the components of the stand 220. The fill line thereby enables a person using the invention to see the level of liquid being placed into the tube 222 to thereby avoid overfilling the tube 222.

The tube 222 may have a generally elongated configuration having an opening proximate an end thereof. Forming the tube 222 with this configuration enables the tube 222 to be held in a person's hand when the product placed in the tube 222 is being consumed. It is possible for the tube 222 to have other configurations. Examples of such alternative configurations include square, triangular and circular.

In certain embodiments, the tube 222 may be formed with a generally cylindrical configuration. In other embodiments, the tube 222 may be formed with a rectangular configuration.

The tube 222 may be formed with a variety of capacities depending on the type of product that is desired to be placed into the tube 222 as well as the intended consumer. In certain embodiments, the tube 222 may have a capacity of up to about 200 milliliters. In other embodiments, the tube 222 may have a capacity of between about 20 milliliters and about 150 milliliters.

The tube 222 may be fabricated from a variety of materials using the concepts of the invention. In certain embodiments, at least a portion of the tube 222 may be formed from a transparent material so that a person using the invention could view the level of liquid in the tube 222.

While it is possible to form the tube 222 from a generally rigid material that retains a cylindrical or elliptical profile when not filed with liquid, the tube 222 may be fabricated from a flexible material that collapses when the tube 222 is not filled with liquid. Providing the tube 222 with a flexible configuration enables the tube 222 to be collapsed during the distribution process prior to use.

In certain embodiments, the tube 222 is fabricated from a plastic material. The material from which the tube 222 should exhibit sufficient structural rigidity so that the at least one tube does not weaken to an extent such that the liquid could leak from the tube 222 at ambient temperatures as well as the reduced temperatures in a conventional residential freezer.

A fill line 246 may be provided on the tube 222 to indicate to persons using the invention how much liquid should be placed in the tube 222. The fill line 246 may be placed in a spaced-apart configuration from the closure mechanism 248 to account for expansion of the liquid placed in the tube 222 when frozen. This configuration thereby minimizes the potential of the closure mechanism failing, which could permit the liquid to leak from the tube 222.

The tube 222 may be provided with a closure mechanism 248 to maintain the tube 222 in a closed configuration after a liquid is placed therein. In certain embodiments, a zipper-type plastic closure system may be provided on the tube 222 proximate an open end thereof. The zipper-type closure mechanism may be similar to aspects of a closure provided on a ZIPLOC bag.

Alternatively or additionally, a closure mechanism (not shown) may be placed over the open end of the at least one tube. In certain embodiments, the closure mechanism may include two sections that are pivotally mounted to each other. A fastener may be provided opposite the pivotal attachment end to maintain the sections in a closed configuration.

The frozen snack preparation system may also include an insertion device 260, as illustrated in FIGS. 4-6. The insertion device 260 may facilitate placing the tubes 222 into the stand 220. The insertion device 260 may also facilitate placing the liquid into the tubes 222.

The insertion device may include a cross member 262 from which a plurality of fingers 264 extend. The number of fingers 264 may correspond to the number of receptacles 224 on the stand 220.

The fingers 264 may have a length that is less than a length of the tubes 222. The fingers 264 may have an at least partially cylindrical shape. Forming the fingers 264 with the at least partially cylindrical shape enables the fingers 264 to move the tubes 222 from a collapsed configuration to a partially expanded configuration. Moving the tubes 222 to the partially expanded configuration facilitates positioning the tubes 222 in the stand 220 as well as facilitates placing liquid in the tubes 222.

A distal end of the fingers 264 may be curved to minimize the potential of the fingers 264 damaging the tubes 222 as the fingers 264 are inserted into the tubes 222. Alternatively or additionally, the fingers 264 may have a tapered profile so that the fingers 264 are smaller proximate a distal end thereof. This configuration may enhance the ability to insert the fingers 264 into the tubes 222.

The fingers 264 may be in fluid communication with the cross member 262 so that a liquid placed in the cross member 262 flows into the fingers 264 and then into the tubes 222. In certain embodiments, the cross member 262 includes an upper side that is at least partially open. Forming the cross member 262 with this configuration allows liquid to be poured into the cross member 262 and then directed into the tubes 222 through the fingers 264.

The cross member 262 may have a U-shaped profile where an open end is oriented upwardly. The fingers 264 may intersect the cross member 262 proximate a lower portion of the U-shape.

Alternatively, it is possible to substantially close the cross member 262 except for an aperture 166 extending from an upper surface thereof as illustrated in the figures. The liquid may be poured into the cross member 162 through the aperture 166. Depending on factors such as the size of the aperture 266 and the rate at which it is desired to fill the tubes 222, a funnel (not shown) may be placed in the aperture 266 to reduce the potential of liquid being spilled during the filling process.

An interior region of the cross member 262 may include at least one divider that extends from proximate the aperture 266 to proximate one of the fingers 264. Since the insertion device 260 is generally symmetrical, each side of the cross member 262 may include two dividers to separate liquid flowing along each side into three liquid flow paths that are each associated with one of the fingers 264.

A support 268 may extend from the cross member 262 to the stand 220 to maintain the cross member 262 in a spaced-apart configuration from the top of the stand 220 so that the tops of the tubes 222 are not crushed when the insertion device 260 is placed on the stand 220.

The insertion device 260 may be fabricated so that it is substantially symmetrical. For example, the insertion device 260 may have front and back sides that are shaped substantially similar to each other. Forming the insertion device 260 with this configuration enables the front and back sides to be molded in a single mold cavity and then attached to each other after the molding process is completed.

In addition to using the frozen snack preparation system in conjunction with a liquid that has been colored and/or flavored, it is possible to fill the tubes with alternative materials. Examples of these alternative materials include soft drinks, fruit juices, gelatin mixes and yogurt.

In the preceding detailed description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The preceding detailed description, therefore, is not to be taken in a limiting sense, and the scope of the present invention is defined by the appended claims.

It is contemplated that features disclosed in this application, as well as those described in the above applications incorporated by reference, can be mixed and matched to suit particular circumstances. Various other modifications and changes will be apparent to those of ordinary skill.

1. A frozen snack preparation system comprising:
a plurality of product containers, wherein each of the product containers has an opening;
a stand having a plurality of receptacles formed therein, wherein each of the receptacles is adapted to receive one of the product containers; and
an insertion device having a plurality of openings formed therein, wherein the plurality of openings are aligned with the plurality of receptacles when the insertion device is in engagement with the stand.
